(19) United States
(12) Patent Application Publication
(10) Pub. No.: US 2008/0156141 A1
(43) Pub. Date: Jul. 3, 2008

(54) CYCLE PEDAL

(76) Inventor: Oz Cabiri, Macabim (IL)

Correspondence Address: David Klein;DEKEL PATENT LTD., Beit Harof'im, 18 Menuha VeNahala Street, Room 27, REHOVOT, omitted

(21) Appl. No.: 11/619,233

(22) Filed: Jan. 3, 2007

(51) Int. Cl. G05G 1/14

(52) U.S. Cl. 74/594.4

(57) ABSTRACT

A cycle pedal including a pedal frame rotatably mounted on a rotation axis of a pedal pin, the pedal pin being securable to a crank arm of a cycle, a clamping mechanism for securing a rider's foot to the cycle pedal, and a ratchet mechanism coupled to the rotation axis and operative to permit rotation of the pedal frame about the rotation axis only in a first direction, wherein in a second direction opposite to the first direction, the ratchet mechanism does not permit rotation of the pedal frame about the rotation axis and is operative together with the clamping mechanism to transmit power in the second direction to the crank arm.

### FIELD OF THE INVENTION

The present invention relates generally to bicycles, and particularly to a bicycle pedal (or tricycle pedal) that is ratcheted for improved power transmission throughout the pedal cycle.

### BACKGROUND OF THE INVENTION

One of the known problems in cycling is transmitting power (that is, moment or torque) as the crank arms rotate at or near bottom dead center and top dead center. The use of toe clips helps but only to a limited extent by applying a force parallel to the pedal movement at the dead centers.

### SUMMARY OF THE INVENTION

The present invention seeks to provide a cycle pedal (for a bicycle, tricycle or the like) that is ratcheted for improved power transmission throughout the pedal cycle, as is described more in detail hereinbelow. The system of the invention is a “moment creator” because it creates a direct moment (torque) via the pedal itself during rotation of the crank arm independent of the crank arm position.

There is thus provided in accordance with an embodiment of the present invention a cycle pedal including a pedal frame rotatably mounted on a rotation axis of a pedal pin, the pedal pin being securable to a crank arm of a cycle, a clamping mechanism for securing a rider's foot to the cycle pedal, and a ratchet mechanism coupled to the rotation axis and operative to permit rotation of the pedal frame about the rotation axis only in a first direction, wherein in a second direction opposite to the first direction, the ratchet mechanism does not permit rotation of the pedal frame about the rotation axis and is operative together with the clamping mechanism to transmit power in the second direction to the crank arm.

The ratchet mechanism may be mounted between the pedal pin and the crank arm. The ratchet mechanism may include, for example, a toothed cog that ratchets with a pawl, the pawl being connected to the crank arm so as to transmit power thereto when the pedal frame moves in the second direction.

When a cyclist pedals with the pedal of the present invention and reaches bottom dead center, the ratchet mechanism together with the clamping mechanism applies power to the crank arm as the rotary motion of the pedal moves from bottom dead center radially upwards about the center of rotation. Furthermore, the present invention provides the rider the possibility of activating movement of the rider's foot at the top down and top up positions. At these positions, forcing the leg down or up will not create any additional moment, but rotating the foot itself against the ratchet mechanism while the foot is locked to the pedal (with toe clips, clamps or other mechanism), creates a moment (torque) that is directly transferred to the crank arm, chain and wheels.

### BRIEF DESCRIPTION OF THE DRAWINGS

The present invention will be understood and appreciated more fully from the following detailed description taken in conjunction with the drawings in which:

FIGS. 1 and 2 are simplified pictorial and sectional illustrations, respectively, of a pedal, constructed and operative in accordance with an embodiment of the present invention.

### DETAILED DESCRIPTION OF EMBODIMENTS

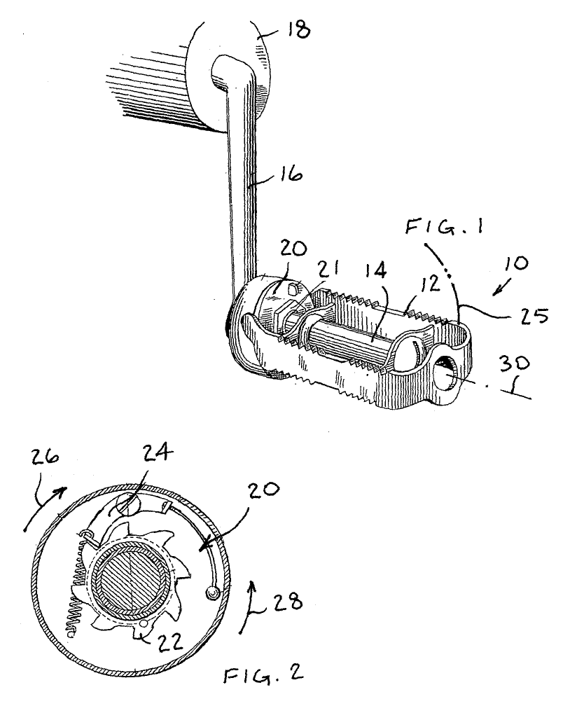

Reference is now made to FIGS. 1 and 2, which illustrate a cycle pedal 10, constructed and operative in accordance with an embodiment of the present invention.

Pedal 10 may include a pedal frame 12 rotatably mounted on a pedal pin 14, which is secured in known (left-handed) threaded fashion to a crank 16 of a cycle 18, such as a bicycle or tricycle or other manual pedal-operated machine. Pedal pin 14 has a rotation axis 30 (longitudinal axis).

A ratchet mechanism 20 is mounted between the pedal pin 14 and the crank 16 (secured, for example, by a nut 21). The ratchet mechanism 20 may include a toothed cog 22 that ratchets with a pawl 24 and transmits power in the direction indicated by arrow 26 to crank 16. This is the direction that the ratchet mechanism 20 does not permit rotation of pedal frame 12 about rotation axis 30. The pawl 24 is connected to the crank 16 so as to transmit power thereto. In the opposite direction, indicated by arrow 28, no power is transmitted to crank 16 by the ratchet mechanism 20 and the pedal 10 acts to move the crank 16 like a regular, non-ratcheted pedal. This is the direction that the ratchet mechanism 20 does permit rotation of pedal frame 12 about rotation axis 30.

It is noted that this is merely one non-limiting example of a ratchet mechanism that may be used to carry out the invention and many other ratchet mechanisms may be used, such as but not limited to, ratchet balls, conic lock ratchets and others.

It is noted that Japanese Patent Document JP1182186 describes a ratchet mechanism in a pedal, but it is different from the present invention. In JP1182186, a ratchet is mounted to the neck part of a pedal shaft having a wide pedal. The ratchet becomes engaged only during stepping downwards the pedal. By stepping on the tip part of the wide pedal, the length of a pedaling force exerting point is increased. JP1182186 does not contemplate creating a moment on the upswing of the pedal rotation (from bottom dead center upwards).

The present invention is most effective when used together with a clamping mechanism 25 (shown in broken lines in FIG. 1 so as not to obscure the other elements). The term “clamping mechanism” encompasses toe clips, clamps, shoes and the like for securing the rider's foot to the pedal. When a cyclist pedals with the pedal 10 of the present invention and reaches bottom dead center, the ratchet mechanism 20 together with clamping mechanism 25 applies power to the crank arm as the rotary motion of the pedal moves from bottom dead center radially upwards about the center of rotation (rotation axis 30 of pedal pin 14). In the present invention, the pedal speed is substantially constant throughout the pedal rotation and the extra power comes from the ratchet mechanism.

It will be appreciated by persons skilled in the art that the present invention is not limited by what has been particularly shown and described hereinabove. Rather the scope of the present invention includes both combinations and subcombinations of the features described hereinabove as well as modifications and variations thereof which would occur to a person of skill in the art upon reading the foregoing description and which are not in the prior art.

What is claimed is:

1. An article comprising:
a cycle pedal comprising a pedal frame rotatably mounted on a rotation axis of a pedal pin, said pedal pin being securable to a crank arm of a cycle;
a clamping mechanism for securing a rider's foot to the cycle pedal; and
a ratchet mechanism coupled to said rotation axis and operative to permit rotation of said pedal frame about said rotation axis only in a first direction, wherein in a second direction opposite to the first direction, said ratchet mechanism does not permit rotation of said pedal frame about said rotation axis and is operative together with said clamping mechanism to transmit power in the second direction to the crank.

2. The article according to claim 1, further comprising a crank of a cycle, said pedal pin being secured to said crank arm.

3. The article according to claim 2, wherein said ratchet mechanism is mounted between said pedal pin and said crank arm.

4. The article according to claim 2, wherein said ratchet mechanism comprises a toothed cog that ratchets with a pawl, said pawl being connected to said crank arm so as to transmit power thereto when said pedal frame moves in said second direction.

5. A method comprising:
providing a cycle pedal comprising a pedal frame rotatably mounted on a rotation axis of a pedal pin, said pedal pin being securable to a crank arm of a cycle, and a ratchet mechanism coupled to said rotation axis and operative to permit rotation of said pedal frame about said rotation axis only in a first direction, wherein in a second direction opposite to the first direction, said ratchet mechanism does not permit rotation of said pedal frame about said rotation axis and is operative to transmit power in the second direction to the crank arm;
securing a rider's foot to the cycle with a clamping mechanism; and
pedaling said cycle pedal, wherein as the rotary motion of the pedal moves from bottom dead center radially upwards about said rotation axis, said ratchet mechanism together with said clamping mechanism applies power to said crank arm.

6. The method according to claim 5, further comprising creating a moment with the ratchet mechanism as the rider's foot moves at top down and top up positions.

7. The method according to claim 5, wherein pedal speed is substantially constant throughout pedal rotation and extra power comes from said ratchet mechanism.
